(19) United States
(12) Patent Application Publication
(10) Pub. No.: US 2014/0115010 A1
(43) Pub. Date: Apr. 24, 2014

(54) PROPAGATING INFORMATION THROUGH NETWORKS

(71) Applicant: Google Inc., Mountain View, CA (US)

(72) Inventors: Rohan Seth, San Francisco, CA (US); Shumeet Baluja, Leesburg, VA (US); Michele Covell, Palo Alto, CA (US)

(21) Appl. No.: 13/778,361

(22) Filed: Feb. 27, 2013

Related U.S. Application Data
(60) Provisional application No. 61/715,646, filed on Oct. 18, 2012.

(51) Int. Cl. G06F 17/30

(52) U.S. Cl. CPC G06F 17/30958
USPC 707/798

(57) ABSTRACT

Methods, and systems, including computer programs encoded on computer-readable storage mediums, including a method for providing a graph that includes entity nodes, label nodes and weighted connecting edges. The method comprises computing an aggregated incoming between-entity edge weight for the entity nodes. When there are positively-weighted incoming between-entity edges into the entity node, the method comprises replacing each of the between-entity edge weights by a pre-normalized between-entity edge weights. The method comprises computing an aggregated from-label weight for the entity node. When there are positively-weighted from-label node edges, the method comprises replacing the corresponding label weights by pre-normalized from-label weights. The method comprises determining influence values for a first, second and third influence factors, where the influence factors have values that sum to one. The method further comprises using the pre-normalized weights and influence factors as a set of linear constraints to determine final label weightings for the entity nodes.

### CROSS-REFERENCE TO RELATED APPLICATIONS

This application claims priority under 35 U.S.C. §119(e) to U.S. Provisional Application Ser. No. 61/715,646 titled “Propagating Information Through Networks” filed Oct. 18, 2012, the disclosure of which is incorporated herein by reference in its entirety.

### BACKGROUND

This specification relates to information propagation.

The Internet provides access to a wide variety of resources. Services, such as social network services enable users to share information in a network of friends, family and other groupings. For example, social networks can permit users to post information about themselves and communicate with other people, such as their friends, family, and co-workers. Some social networks permit users to specify affinity relationships (e.g., friendships) with other users. Additionally, some social networks may enable their users to provide information pertaining to their interests (e.g., what they like). Interest information can be shared and/or used to select content for presentation to the user or others related to the user.

### SUMMARY

In general, one innovative aspect of the subject matter described in this specification can be implemented in methods that include a method for propagating labels through graph-based structures. The method comprises providing data representing a data structure that includes a plurality of nodes, a portion of the nodes being entity nodes and a portion of the nodes being label nodes. At least some of the entity nodes are connected to other entity nodes by one or more incoming or outgoing weighted edges. At least some of the label nodes are connected to entity nodes by one or more outgoing weighted edges. For each entity node: the method further comprises computing an aggregated incoming between-entity edge weight for the entity node including adding the weights of the edges that are incoming to the entity node from other entity nodes. The method further comprises when there are one or more positively-weighted incoming between-entity edges into the entity node, replacing each of the between-entity edge weights by a respective initial edge weight of the between-entity edge divided by the aggregated incoming between-entity edge weight to generate pre-normalized between-entity edge weights. The method further comprises computing an aggregated from-label weight by adding the label weights from label nodes with edges that are incoming to the entity node. The method further comprises when there are one or more positively-weighted from-label edges into the entity node, replacing each of the corresponding label weights from the label nodes by a respective initial label weight from the label node divided by the aggregated from-label edge weight to generate pre-normalized from-label weights. For each entity node, the method further comprises determining influence values for each of a plurality of influence factors, where each influence factor is associated with a degree of propagation through the data structure of label weights to the entity node. The influence values are all non-negative and sum to one. The method further comprises using the pre-normalized from-label weights, the pre-normalized between-entity edge weights and the influence values as a set of linear constraints to determine final label weightings for the entity nodes.

These and other implementations can each optionally include one or more of the following features. The method can further comprise identifying the entity node as a without-direct-label node when there are no positively-weighted from-label edges into the entity node. The method can further comprise, for each entity node that is both a disconnected entity node and a without-direct-label node, removing the entity node from the data structure and removing any edges that originate from the entity node.

The method can further comprise determining the final label weighting for the entity nodes including, for one or more iterations: propagating label weights from a previous iteration from each entity node to the other entity nodes to which the entity node is directly connected using a first propagation weighting given by a multiplicative combination of the between-entity edge weights and a second influence factor from incoming-from-entity-node edges, from the plurality of influence factors, for an entity node receiving the propagated label weights; propagating labels from each label node to the entity nodes which the label node is directly connected using a second propagation weighting given by a multiplicative combination of the from-label edge weights and a first influence factor from direct-from-label injections, from the plurality of influence factors, for the receiving entity node; and summing the propagated labels on a per-label basis to provide a current iteration's label weight for each entity node.

The method can further comprise determining the final label weightings for the entity nodes by solving a set of linear constraints using bi-conjugate gradient descent. Determining the final label weightings can comprise eliminating label nodes and bypassing the computation of a label's distribution for all labels whose final distribution does not substantially affect a solution to the set of linear constraints. Determining the final label weightings can comprise eliminating label nodes and bypassing the computation of a label's distribution for all labels whose final distribution does not substantially affect a solution to the set of linear constraints. Determining the final label weightings can comprise eliminating entity nodes from the computation for all entity nodes whose final label weighting does not substantially affect a solution to the set of linear constraints.

Eliminating entity nodes from the computation can comprise eliminating entity nodes by Gaussian elimination of the entity node while maintaining the entity node's influence on a final weighting distribution. The entity nodes can represent social entities and the label nodes can represent interest. The edge weights between entity nodes can be determined by a number, length, or recentness of a message exchanged between the social entities. The entity nodes can represent advertisement sites and the label nodes can represent advertisement triggering keywords. The edge weights between entity nodes can be determined by a number, consistency, or recentness of user visits to the advertisement sites within a single user session and within a pre-defined time period.

The entity nodes can represent content sites and the label nodes can represent content topics. The edge weights between entity nodes can be determined by a number, consistency, or recentness of user visits to the content sites within a single user session and within a pre-defined time period.

The method can further comprise, when there are no positively-weighted incoming between-entity edges into the entity node, identifying the entity node as a disconnected entity node. The influence value for the first influence factor can be set to zero for the entity nodes that are identified as a without-direct-label node and the influence value for the second influence factor can be set to zero for entity nodes that are identified as a disconnected entity node.

In general, another innovative aspect of the subject matter described in this specification can be implemented in methods that include a method for propagating labels in a social graph. The method comprises providing a social graph that includes a plurality of nodes and includes edges connecting the nodes. A portion of the nodes are user nodes, a portion of the nodes are injection nodes that inject a label into a respective user node and a portion of the nodes are uncertainty nodes that inject a measure of attenuation to be applied when propagating labels between user nodes. The method further comprises determining for a given node an influence value for label weights for each of three factors: influence for injections, influence for neighbors and influence for uncertainty. The method further comprises determining weights for labels at each node including normalizing at receipt weights for labels that are propagated or injected into a user node including: normalizing the weights for labels injected into a node, and adjusting the normalized weights by the influence factor for injections to produce an injected label weight contribution for the label for the node. The method further comprises adjusting the weights for labels received from a neighbor by the influence factor for neighbors to produce a neighbor label weight contribution for the label for the node. The method further comprises using the weights and influence values as a set of linear constraints to determine final label weightings for the nodes.

These and other implementations can each optionally include one or more of the following features. The influence factors can sum to one. Normalizing at receipt weights for labels can include determining for each neighbor a contribution for a label being propagated to a target user node from the neighbor. Normalizing on receipt can further include determining an influence factor for each neighbor that is contributing labels to a target user node, adjusting a label weight for a label propagated from the neighbor in accordance with the neighbors influence to produce a first adjusted label weight, and adjusting the first adjusted label weight by the influence factor for neighbors to produce the neighbor label weight contribution for the node. The influence factors for each neighbor can sum to one. The influence factors for each neighbor can be the same.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example graph of a social network system.

FIG. 2 is a schematic of an example system for determining label information.

FIG. 3 is a block diagram of an example system that determines labels for members of a social network system.

FIG. 4A is a flow diagram of an example process for propagating information through a graph-based representation.

FIG. 4B is a flow diagram of an example process for determining label weight values.

FIG. 5 is example graph of a social network where a pre-normalized set of linear constraints are used during label propagations.

FIG. 6 is a block diagram of example computing devices that may be used to implement the systems and methods described in this document.

Like reference numbers and designations in the various drawings indicate like elements.

### DETAILED DESCRIPTION

This document describes systems and techniques for propagating information in a network, for example, through graph-based representations (e.g., data structures). For example, such graph-based representations can include representations of social networks. Graph-based representations can also, for example, include representations of a network of users of a service, with connections and connection weights between the users made according to the similarity of the actions that the users of the service have taken in the past. For example, the service could be a search engine, with the users being individuals and the past actions being their query topics. Alternately, the service could be a content network, with the users being content sites and the “past actions” being co-visitation across sites.

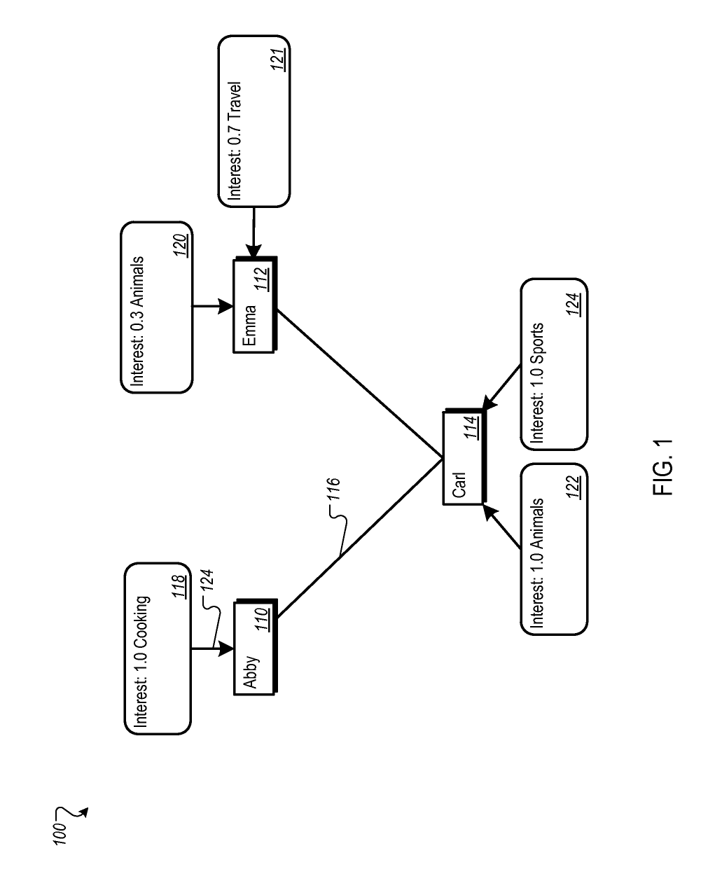

As described below, it is useful to represent such systems as graphs. For example, a system may include many constituent elements that can be represented as nodes in the graph and the relationships between the elements can be represented by connections or edges between the nodes. Thus, for example, the graph may represent a social network (i.e., the system) with social network members and labels associated with the members represented by nodes in the graph. Relationships among the members (e.g., friendships) and associations between members and labels can be represented in the graph by edges between the nodes, as shown in FIG. 1.

FIG. 1 is an example graph 100 of a social network system (i.e., a graph-based representation of a social network). The graph 100 represents a social network with three members: Abby, Emma and Carl. Although for exemplary purposes graph 100 represents a social network with only three members, graphs can represent social networks with any number of members (for example, tens of thousands or millions of members) in an analogous manner and the methods and techniques described in this document apply equally to such other, larger graphs.

As described above, each of the members of the social network 100 can be represented as a node in the graph 100. For example, Abby, Emma and Carl are represented by entity (or user) nodes 110, 112, and 114, respectively. In some implementations, the entity nodes are linked by edges based on social relationships specified by the members or otherwise known. For example, the entity node 110 is linked by edge 116 to entity node 114 because, for example, Abby has specified that Carl is a friend (e.g., on her profile page). Further, entity node 110 and entity node 112 are not linked by an edge as, for example, neither Abby nor Emma has indicated they are friends or otherwise acquainted. FIG. 1 also shows label (or injection) nodes 118-122 that associate entity nodes with labels having weights that reflect a probable interest of the corresponding member.

For example, the entity node 110 is associated with label node 118 having an interest or label weight 1.0 for the Cooking label, which reflects how much the label should contribute to the entity node. Thus label node 118 is connected to the entity node 110 by edge 124. The label Cooking specifies that Abby is interested in cooking based, for example, on information in Abby's member profile. Abby's interest can be determined explicitly or implicitly from various sources, such as from Abby's profile page where Abby can indicate an interest weight for cooking of 1.0.

The entity node 112 is associated with a label node 120, which specifies that Emma has interests in Animals (interest weight 0.3) and Travel (interest weight 0.7). The interest weight for Emma's interest in Animals can be based, for example, on Emma's membership in an endangered animal preservation group of the social network. The interest weight for Emma's interest in Travel can be based, for example, on entries by Emma in her member profile.

The entity node 114 is associated with the label node 122. Carl's interest in Animals and Sports can be based on, respectively, Carl's membership in the endangered animal preservation group and entries by Carl in his member profile. In this way, the graph 100 represents the social network of Abby, Emma and Carl.

Representing such systems as graphs permits the systems represented by the graphs to be mathematically modeled (e.g., as matrixes), which, in turn, allows various mathematical tools to be applied to the systems to determine or predict how information will flow or propagate through the systems or, more generally, how the systems will react to stimuli introduced to the systems. For example, in the case of a graph-based representation of a social network, a first social network member can indicate an interest in a particular topic by, for example, updating the first member's social network profile to include the interest or posting a comment expressing the first member's interest in the topic. For other social network members having a relationship with the first member (e.g., a friendship relationship), it is likely such other members also have the same or similar interests as those of the first member. Thus the interests of the first member can be propagated from the first member to other members that have a relationship with the first member to, for example, infer interests of the other members (e.g., as there may be little or no information known about the other members). Such propagation can be facilitated by representing the social network as a graph (or matrix) and applying various mathematical tools as described below.

It can be readily appreciated that modeling a complex system and iteratively propagating information through a graph representing the system can be computationally intensive, prohibitive or otherwise challenging. For example, over time the members of a social network will change as will the interests (e.g., labels) of such members and iterative processing of the graph representing the social network will be necessary to account for changes in the social network.

Further, as many solutions to iteratively propagating information through a graph require renormalization of label weights (e.g., propagated information) at each node after each iteration, standard sparse-matrix solution approaches or other similar mathematical approaches that aid in determining how information is propagated in the graph cannot be effectively utilized.

As described below, the systems and methods described in this document facilitate the propagation of information through graph-based representations by using a set of constraints on the propagation that, in effect, “pre-normalize” the information (e.g., label weights) in the graph such that renormalization of the information is not required after each propagation iteration. In other words, by using the set of constraints, solutions that determine how information propagates through a graph result in label weights that are inherently normalized after propagation such that renormalization after propagation is not required. As such, this advantageously permits standard sparse-matrix solution approaches to be used. This pre-normalization can be a preprocessing step that occurs prior to propagating information and, thus, the pre-normalization refers to a pre-propagation normalization process that does not need to be repeated after each propagation iteration.

For exemplary purposes only, this disclosure will focus on propagating information through a graph representing a social network. However, such propagation techniques and methods are equally applicable to any other systems represented or representable by a graph or other mathematical construct such as a matrix (e.g., content networks or networks of search-engine users).

Social networks can host information about, and generated by, the social networks' members. For example, members can create and distribute member content and provide profile information (e.g., member profiles), which can include interests, stories, facts or descriptions about a member. In some implementations, member interests can be determined from what the member likes, content on which the member performs an action (e.g., distribution or re-distribution), or any other member-specified preference or member-performed action related to interests. Additionally, the members can specify social relationships with other members. For example, a member can specify other members that are “friends” and or “enemies.” The construct of friends and enemies is binary. In some social networks, analog (e.g., degrees of friendship) constructs can be supported. In another example, a member can specify that they are similar to another member or similar (or dissimilar) to a certain degree.

Content delivery systems can deliver online content (e.g., advertisements or “ads”) to members of a social network based on their interests, e.g., determined from the content of their member profiles. For example, labels can be associated with a member, and the labels can be used in delivering content (e.g., ads) to that member. In some situations, a member may not provide enough (or any) information (e.g., in the member profile), or the member's interests may not be known, which may make it difficult to provide online content that is interesting to a given member. In general, content delivery systems can select content that corresponds to a member's interests. Advertising systems are just one example type of content provider which can deliver content using labels based on member interests.

Labels can be associated with (or assigned to) a member in various ways. For example, labels can be assigned based on an evaluation of content associated with a member, including the member's likes, web pages visited by the member, the member's location, demographic information for the member, and so on. Labels can be assigned based on a combination of explicit designations (e.g. information supplied by the member) and implicit determinations (e.g., labels inferred for the member). Implicit determinations can be based on member interaction with content, such as click-throughs, conversions, etc. Labels associated with each member may have associated label weights that reflect a level of interest by the member in the information associated with the labels. By way of example, using percentages in the range of 0 to 100% to designate label weights, percentages ranging from 0%-30% can designate a low interest, 31%-70% can designate a moderate interest, and 71%-100% can designate a high interest. Additionally, as another example, label weights may also be represented as decimal values in the range of 0 to 1, where 0.00 to 0.30 may reflect a low interest, 0.31 to 0.70 may reflect a moderate interest, and 0.71 to 1.00 may reflect a high interest

In the situation where a first member's interests are not known (e.g., the first member lacks information in his profile), interests of other members that are related to the first member can be used for selecting content to be delivered to the member. As described above, in some implementations, labels associated with a member's friends can be propagated to the member, and the propagated labels can be used to select content (e.g., these propagated labels can be used as inferred interests). For example, a first member may not have any information in his profile except that he has two friends, second member and third member. A server system can use information from the second and third member profiles and/or other interest information to infer information about the first member's interests. For example, the inferred information can be used to select online ads that are displayed when first member's profile is viewed. Selection can occur regardless of whether the interests are explicitly determined for the member, or are implicitly determined, such as by member actions or by propagating labels (and interests) inferred from other members.

In some implementations, labels can be propagated to member groups, e.g., member networks or member circles. For example, a label that is propagated to a member group can be propagated to each member in the member group, or to the member group itself, or a combination of both.

In some implementations, when a label is propagated from node A to node B, as used in this disclosure, it means that, if node B already has that label, then node B's label weight is updated based on the value of the node A's label weight for the same label. If node B does not already have that label, then the label is created for node B and is assigned a label weight that is based on the value of node A's label weight for that label.

As described above, member interests can be determined implicitly based on member activity. For example, a member's search logs or search history can be used to determine which web pages the member has visited. If, for example, web histories for the member indicate that the member spent a significant amount of time on sports-related websites, then an implicit determination can be made that the member is interested in sports. Further, the relative number of sports-related websites visited and/or the relative amount of time that the member spent on the web sites can indicate the degree of interest of the member. Search logs and search histories can be anonymized so that the privacy of members is protected. For example, quasi-unique identifiers can be associated with members, but the actual identifying information of the members is not stored in the search logs. Additionally, any identified member preferences or member interactions can be generalized (for example, generalized based on member demographics) rather than associated with a particular member. Encryption and obfuscation techniques can also be used to protect the privacy of members. In some cases, members can be provided the opportunity to opt/in or out of such information collection.

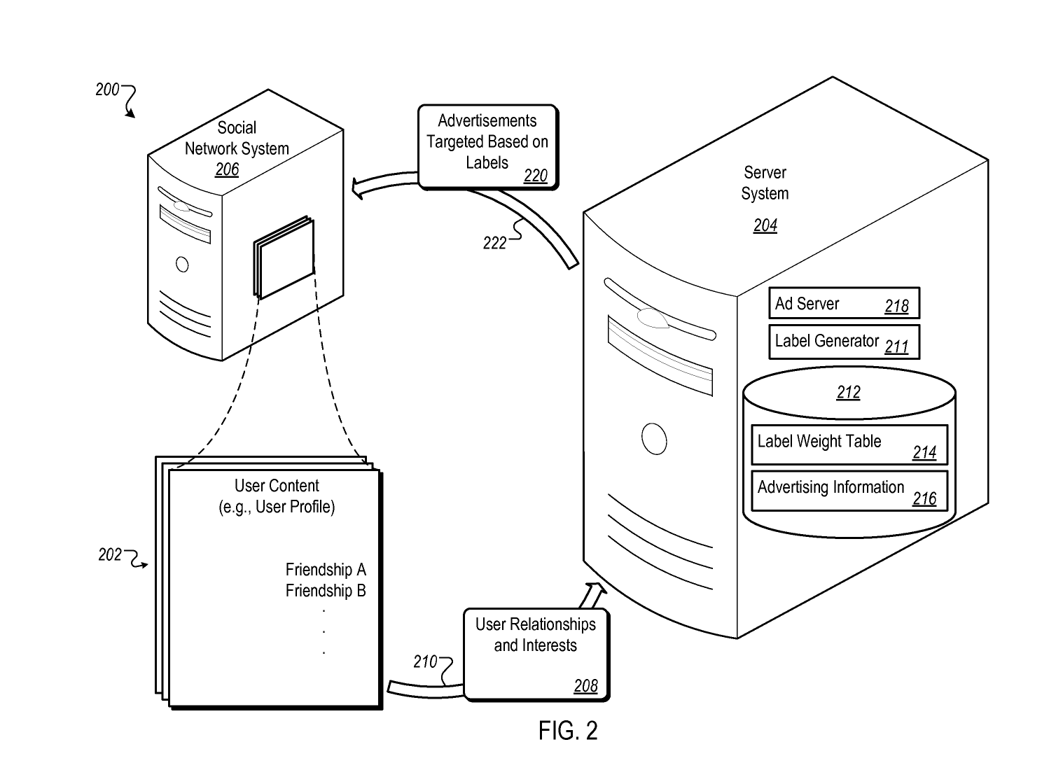

FIG. 2 is a schematic of an example system 200 for determining label information. Specifically, the label information can include content-selection labels for a first social network member that are determined based on label information of another member who is socially related to (e.g., a friend of) the first social network member. In some implementations, the system 200 includes a social network system 206 and a server system 204, which can, for example, determine associations between content in individual members' profiles based on social relationships specified by the profiles.

In some implementations, the social network system 206 includes the member content 202, which can include member-generated content, such as member interests, member blogs, postings by the member on the member's profile or other members' profiles (e.g., comments in a commentary section of a web page), a member's selection of hosted audio, images, and other files, and demographic information about the member.

Additionally, the member content 202 can include social relationships that specify associations between members of the social network system 206. For example, a member Joshua may list Aaron and Caleb as friends, and Joshua may be a member of the Trumpet Player Society, which includes Izzy as a second member. The specified friendship and group membership relationships can be used to infer a similarity or dissimilarity (and degrees thereof) in member interests among the members Joshua, Aaron, Caleb, and Izzy.

Information, or content 208, of the member content 202 can be transmitted to the server system 204, as indicated by an arrow 210. The server system 204 can use a label generator 211 to create labels for members for which interests are not well known (e.g., members having incomplete or sparsely populated member profiles) based on content associated with related members (e.g., profiles of friends or members of the same group, clubs, society, etc.).

In some implementations, the labels can include keywords associated with the profiles. For example, a label may be a keyword (e.g., “cars”) that is included in a profile. In some implementations, the labels may be categories associated with content in a profile, for example, a profile can include content describing car model A, car model B and car model C. A label applied to the profile may be “cars” based on predetermined associations between the car model A, car model B and car model C terms and the category “cars.”

In the implementation shown in FIG. 2, the server system 204 includes a data store 212, where information about the labels can be stored. In some implementations, each member profile may be associated with more than one label. The associations between each profile and corresponding labels can be stored in a data structure, such as a label weight table 214.

In some implementations, the label weight table 214 can also include label weights that indicate a possible interest level for each label. For example, Adam's profile can include content about gardening and animal husbandry, but twice as much content may be focused on gardening. The label weight table 214 can include an interest label weight of 0.66 for gardening and 0.33 for animal husbandry under Adam's profile entry, which is one way to indicate the profile includes twice as much information on gardening as animal husbandry.

The data store 212 can also include advertising information 216 used to generate/select online advertisements (ads) 220 directed to profiles hosted by the social network system 206. The online advertisements 220 can be transmitted by an ad server 218 hosted by the server system 204. The ad server 218 can use the label information in the label weight table 214 to generate/select online ads 220 for members based on labels associated with the member profiles. For example, the server system 204 can transmit, as indicated by arrow 222, the target ads 220 to the social network system 206 for display with the member profiles or to the members associated with the member profiles. While reference is made to targeting and serving ads, other forms of sponsored content can be served.

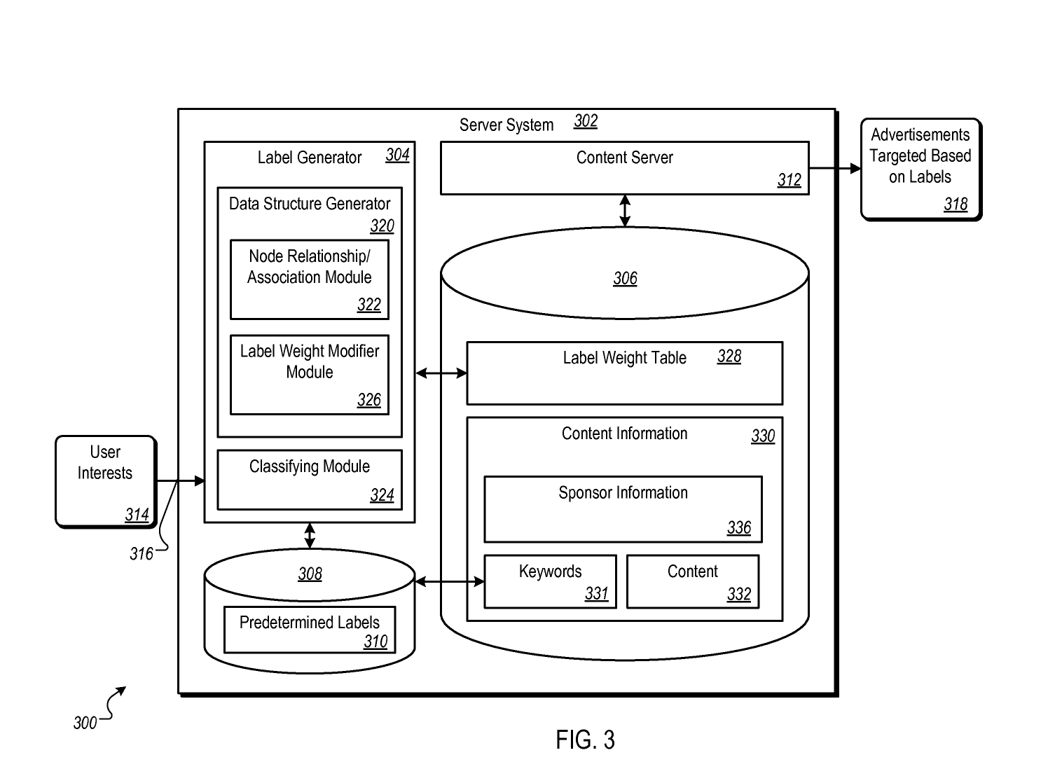

FIG. 3 is a diagram of an example system 300 that infers labels for member profiles hosted by a social network system. The server system 302 includes a label generator 304, a first data store 306 that includes label and content information, a second data store 308 that includes predetermined labels 310, and a content server 312.

In some implementations, the server system 302 can receive content 314, e.g., including user interests from member profiles of a social network system, as indicated by arrow 316. The server system 302 can use the content 314 to identify or generate labels based on the content 314, where the labels can be used to generate or identify online content items (e.g., ads 318) that are selected for presentation to corresponding members or member profiles.

In some implementations, the label generator 304 includes a data structure generator 320 that can create a data structure used to infer the labels. In some implementations, the data structure generator 320 can generate a graph, where each member is represented by a node in the graph (e.g., graph 100). However, the graph data structure is just one of several data structures or mathematical representations that can be used to represent members, and associated labels in a network.

The data structure generator 320 can include a node relationship/association module 322 that associates label nodes with associated entity nodes with edges based on associations between the label and entity nodes, and links entity nodes to other entity nodes with edges based on social relationships specified by (or otherwise known about) the members. For example, a member Adam may specify in his profile that Seth is a friend. The node relationship/association module 322 can join the entity nodes for Adam and Seth with an edge. The edges may be bi-directional or uni-directional; however for the purposes of simiplicity, the edges in the following examples are bi-directional unless otherwise specified.

In some implementations the edges between entity nodes can be weighted. In some implementations, the relative strength of a friendship between two members can be used to generate a numeric edge weight on the edge in a graph that connects the members' corresponding entity nodes. For example, Adam may specify that he likes Jack where the weight associated with liking Jack is 0.8. As such, the edge between the entity nodes representing Jack and Adam can have an edge weight of 0.8. Adam may also indicate that he likes Jill half as much as Jack. In this example, the edge between the entity nodes representing Jill and Adam can have an edge weight of 0.4.

Edge weights can also or alternatively be based on various other factors including, for example, a measure of degree of relatedness to or interactivity with an entity node and other entity nodes in the graph. For example, two entity nodes that share a significant number of interests (e.g., as indicated by a significant overlap of labels in the two nodes) can have a relatively high edge weight, leading to a potentially greater propagation of labels and weights between the entity nodes, as described below.

In some implementations, the edge weight can be used (e.g., as a multiplier) in determining the extent that a label weight is propagated to a neighboring entity node. For example, label weights that are propagated between two strong friends can use higher weights than those used for two members having a weaker relationship.

The label generator 304 also includes a classification module 324, which can associate members of the social network system with labels, such as the predetermined labels 310 in the second data store 308. These associations can be used by the node relationship/association module 322 to link label nodes to entity nodes. The classification module 324, for example, can use text analysis techniques based on support vector machine and k-nearest neighbor analyses to associate members with labels. Such text analysis can be used to determine labels to associate with entity nodes in a graph-based representation. The subject of the analysis can include member profiles, comments posted by a member, descriptions of groups to which a member belongs, etc. In some implementations, the predetermined labels 310 can be based on keywords, which are submitted by content sponsors (e.g., advertisers). For example, the keywords can include the term “furniture.” This can be used as a predetermined label, which the classifying module 324 associates with members that have profiles that include the term “furniture.” Additionally, the classifying module 324 can associate the members with the label “furniture” if the member profiles include words that are associated with “furniture,” such as chair, table, or home decorating.

Given the labels generated by the label generator 304, in some implementations, the content server 312 can use the labels to select content (e.g., ads) to display. For example, if an entity node is associated with the label Music Star A, the content server 312 can select music content to display with a member profile associated with the entity node. In another example, if the label is Religion, then the content server 312 can select content that is determined to be religious or content that a sponsor specified to be displayed based on an occurrence of terms relating to religion.

In certain implementations, after a number of iterations, the label generator 304 can examine one or more of the entity nodes and/or label nodes of the graph and probabilistically assign a label to each entity node based on the weights of the labels (e.g., a label with the maximum label weight can be assigned to the node).

In some implementations, the number of the iterations is specified in advance. In some implementations, the algorithm terminates (or can terminate early) when the label weights for the labels at each entity node reach a steady state (e.g., a state where the difference in the label weight change between iterations is smaller than a specified epsilon).

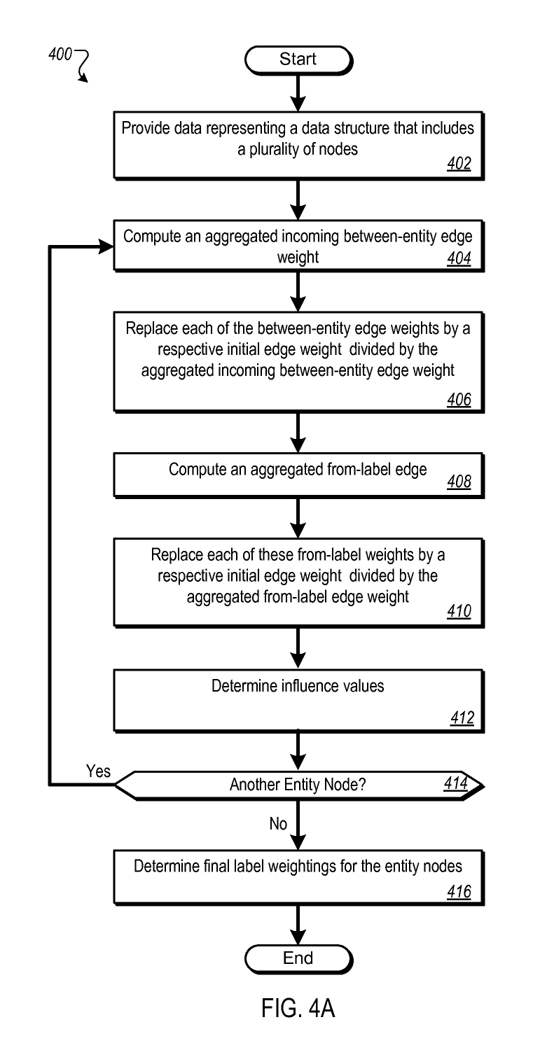

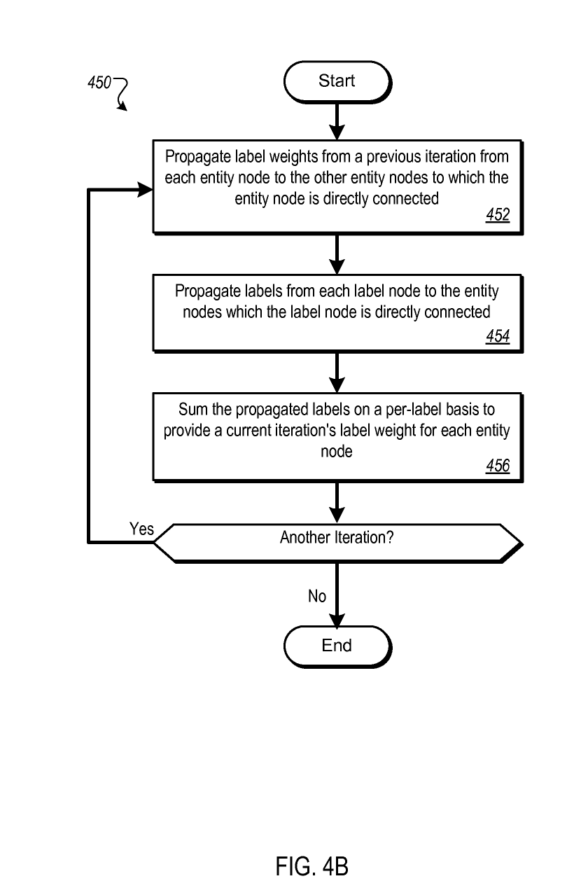

In some implementations, the label generator 304 also includes a label weight modifier module 326. Initial and modified label weights can, in some implementations, be stored in a data structure, such as a label weight table 328 of the first data store 306. For example, the label weight table 328 can include label weights for interest labels associated with members, groups of members, or other associations. The label weight modifier module 326 can modify label weights associated with members using methods and structures more fully described below. For example, modifications to the weights can occur during propagation of labels among members, as described below with reference to FIG. 4A.

FIG. 4A is a flow diagram of an example process 400 for propagating information through a graph-based representation. In some implementations, the method 400 includes steps that can be implemented as instructions and executed by one or more processors in a computer system or network, e.g., in the server system 302.

The method 400 provides data representing a data structure (e.g., a graph) that includes a plurality of nodes and weighted edges connecting the nodes (402). In some implementations, the label generator 304 can provide such a graph. A portion of the nodes can be entity nodes and another portion of the nodes can be label nodes. The entity nodes can be connected to other entity nodes by one or more incoming or outgoing weighted edges. For example, the label generator 304 can create a graph (e.g., graph 100) that represents a social network, where each entity node represents a member in the social network and each label node represents one or more labels with corresponding label weights. In some implementations, the label generator 304 can generate one or more incoming or outgoing weighted edges for particular entity nodes based on relationships between the entity nodes. For example, the label generator 304 can generate incoming or outgoing weighted edges for the entity nodes representing social network members to represent social connections (e.g., friendships) between the members. The magnitudes of the weights of the edges can represent and correspond to the extent to which the members represented by the entity nodes are related. For example, if two members have each expressly indicated they are friends and are both members of the same membership groups, then the weight of the edge between the representative entity nodes will be higher than the weight of an edge between two entity nodes representing other members that are only related by common membership in a member group.

In some implementations, the label generator 304 can connect label nodes to entity nodes by one or more outgoing weighted edges. In some implementations, the label generator 304 can connect label nodes to entity nodes based on the associations of members to labels generated by the classification module 324. The label nodes can be used to inject labels (e.g., indications of interest) into label sets of the entity nodes. As described above, labels include one or more designators for areas of interest for a member. For example, labels can include both categories of interest (e.g., Travel, Music, Dogs, Movies, Business, etc.) and keywords (Music Star A, Tables, Masks, etc.). For example, if a label node represents a Travel label and is associated with entity node A, the label generator 304 can cause the Travel label (e.g., all or a portion of the travel label's weight) to be injected or assigned to entity node A to indicate that the member represented by entity node is interested or likely interested in travel.

Each label weight reflects a magnitude of a contribution of an associated label to a characterization of the member represented by the respective entity node. For example, for any particular entity node, there can be several labels which correspond to the represented member's interest (e.g., an interest in content associated with the label). The member's profile, for example, may indicate that the member has a strong interest in Cats and a small interest in Dogs. As a result, the classifying module 324, for example, can assign a weight of a greater magnitude to the Cats label, and a weight of a lesser magnitude to the Dogs label. These weights can be added to or otherwise included with any existing labels associated with (e.g., previously injected into) the member's entity node.

As with the edges between entity nodes, the label generator 304 can weight the edges between entity nodes and label nodes based on strengths of or confidences in the associations between the represented members and labels. For example, the label generator 304 can more heavily weight the edge between a first entity node and a first label node as compared to the edge between the first entity node and a second label node if the association between the first entity node and first label node is based on an explicit association (e.g., the represented member indicates his interest in the represented label in the member's profile) and the association between the first entity node and second label node is based on an inferred association (e.g., the represented interest is inferred through the member's affiliation with a group concerned with the interest). Injecting labels into entity nodes is described in more detail below.

The method 400, for each entity node, computes an aggregated incoming between-entity edge weight for the entity node including adding the weights of the edges that are incoming to the entity node from other entity nodes (404). In some implementations, the aggregated incoming between-entity edge weight for a particular entity node is the sum of the weights of all of the edges between other entity nodes and the particular entity node (i.e., the edges connecting to the particular entity node from other entity nodes). For example, entity node 114 is connected to (i) entity node 110 with an edge having an initial edge weight of 0.4 and (ii) entity node 112 with an edge having an initial edge weight of 0.1 then the aggregate incoming between-entity edge weight for entity node 114 can be assigned 0.5 (0.4+0.1). However, entity nodes can be connected to more or less than two other entity nodes. In some implementations, the label generator 304 computes an aggregated incoming between-entity edge weight for the entity node. Based on the above example, and the graph 100, the aggregated incoming between-entity edge weights for entity nodes 110, 112 and 114 are given in Table 1:

TABLE 1

| | Aggregated Incoming Between-Entity Edge Weight |
|---|---|
| Entity Node 110 | 0.4 |
| Entity Node 112 | 0.1 |
| Entity Node 114 | 0.4 + 0.1 = 0.5 |

As entity nodes 110 and 112 are only connected to entity node 114, their respective aggregated incoming between-entity edge weights are the edge weights of the respective edges connected to entity node 114.

When there are one or more positively-weighted incoming between-entity edges into the entity node, each of the between-entity edge weights can be replaced by a respective initial edge weight of the between-entity edge divided by the aggregated incoming between-entity edge weight to generate pre-normalized between-entity edge weights (406). In some implementations, an initial edge weight of the between-entity edge of a pair of entity nodes is the edge weight of the edge between the pair of entity nodes used to generate the most recent aggregated incoming between-entity edge weight for the pair. For example, the initial edge weight of the between-entity edge for entity nodes 110 and 114 is 0.4.

In some implementations, the label generator 304 replaces each of the between-entity edge weights for a particular entity node and each other entity node connected to the particular entity node (a “neighboring node”) by the quotient of the respective initial edge weight of the between-entity edge of the pair divided by the aggregated incoming between-entity edge weight for the particular entity node to generate pre-normalized between-entity edge weights for the particular entity node.

The pre-normalized between-entity edge weights (or first adjusted label weights) are generated from a particular entity node's perspective. As such, for two entity nodes that are connected, the pre-normalized between-entity edge weight of the edge between the entity nodes can vary, for example, based on the number of other entity nodes to which the entity node of interest is connected. For example, as entity node 114 has positively-weighted incoming between-entity edges, the label generator 304 replaces the between-entity edge weight of the edge between entity node 114 and entity node 110 with a pre-normalized between-entity edge weight of 0.4/(0.04+0.1)=0.8 (i.e., the pre-normalized between-entity edge weight for entity node 114 for the edge between entity nodes 114 and 110).

However, the pre-normalized between-entity edge weight for entity node 110 for the edge between entity nodes 110 and 114 is 0.4/0.4=1.0. The difference is a result of the entity node 110 being only connected to entity node 114 (whereas entity node 114 is connected to both entity nodes 110 and 112). Thus, the aggregated incoming between-entity edge weight for entity node 110 is the same as the initial between-entity edge weight of entity nodes 110 and 114. In contrast, the aggregated incoming between-entity edge weight for entity node 114 is different from the initial between-entity edge weight of entity nodes 110 and 114 and, thus, the pre-normalized between-entity edge weights for entity nodes 110 and 114 are different. The pre-normalized between-entity edge weights for entity nodes 110, 112 and 114 are given in Table 2:

TABLE 2

| | Pre-Normalized Between-Entity Edge |
|---|---|
| | Weight |
| Entity Node 114: Edge from 110 | 0.8 |
| Entity Node 114: Edge from 112 | 0.2 |
| Entity Node 110: Edge from 114 | 1.0 |
| Entity Node 112: Edge from 114 | 1.0 |

An aggregated from-label weight is computed, for example, by adding the label weights from label nodes with edges that are incoming to the entity node (408). The aggregated from-label weight for a particular entity node is the sum of the label weights from all label nodes with edges that are incoming to the particular entity node. For example, as the entity node 114 is connected to (i) the label node 122 by an incoming edge and has an Animals label weight of 1.0 and (ii) the label node 124 by an incoming edge and has an Sports label weight of 1.0, the aggregate from-label weight for entity node 114 is 2.0 (1.0+1.0). However, entity nodes can be connected to more or less than two label nodes. For example, entity node 110 is connected to only one label node 118.

In some implementations, the label generator 304 computes an aggregated from-label weight for the entity node. Based on the above example, and the graph 100, the aggregated from-label weight for entity nodes 110, 112 and 114 are given in Table 3:

TABLE 3

| | Aggregated From-Label Weight |
|---|---|
| Entity Node 110 | 1.0 |
| Entity Node 112 | 0.3 + 0.7 = 1 |
| Entity Node 114 | 1.0 + 1.0 = 2.0 |

As entity node 110 is only connected to one label node (e.g., label node 118), its aggregated from-label weight is the label weight of label node 118.

When there are one or more positively-weighted from-label node edges into the entity node, each of the corresponding label weights from the label nodes is replaced by a respective initial label weight from the label node divided by the aggregated from-label weight to generate pre-normalized from-label weights (410). In other words, the from-label node edges are edges from label nodes with labels being injected into a particular entity node (“injected label nodes)”. An initial label weight of an injected label node is the label weight of the label node used to generate the most recent aggregated from-label weight for the entity node. For example, the initial label weight of the label node 121 for the entity node 112 is 0.7.

In some implementations, the label generator 304 replaces each of the label weights incoming to (e.g., being injected into) a particular entity node by the quotient of the respective initial label weight of the injected label node divided by the aggregate from-label weight for the particular entity node to generate pre-normalized from-label weights for the particular entity node. The pre-normalized from-label weights for entity nodes 110, 112 and 114 are given in Table 4:

TABLE 4

| | Pre-Normalized From-Label Weight |
|---|---|
| Entity Node 114: Label Node 122 | 1.0/(1.0 + 1.0) = 0.5 |
| Entity Node 114: Label Node 124 | 1.0/(1.0 + 1.0) = 0.5 |
| Entity Node 110: Label Node 118 | 1.0/1.0 = 1.0 |
| Entity Node 112: Label Node 120 | 0.3/(0.3 + 0.7) = 0.3 |
| Entity Node 112: Label Node 121 | 0.7/(0.3 + 0.7) = 0.7 |

Influence values for each entity node for each of one or more influence factors are determined (e.g., a first influence factor from direct-from-label injections, a second influence factor from incoming-from-entity-node edges, and a third influence factor from uncertainty) (412). In some implementations the label generator 304 determines the influence values or accesses data specifying the influence values from the first data store 306 that store influence values for the entity nodes. In some implementations, uncertainty (or uncharacterized) nodes can be included in the graph that inject the values of one or more of the influence factors into the respective entity nodes (in a manner similar to that of label nodes).

An influence factor for an entity node generally specifies a measure of influence or effect a particular source or element in the graph has on labels injected into or otherwise propagated to the entity node. More particularly, the first influence factor (or injection influence factor) specifies a measure of influence of labels injected into an entity node directly from label nodes. High-valued first influence factors indicate that labels injected into an entity node will have a greater effect on the entity node's label weights than will low-valued first influence factors.

The second influence factor (or neighbor influence factor) specifies a measure of influence of labels propagated to an entity node from other entity nodes directly connected to the entity node. Similarly to the first influence, factor high-valued second influence factors indicate that labels propagated to an entity node will have a greater effect on the entity node's label weights than will low-valued second influence factors.

The third influence factor (or uncertainty influence factor) specifies a measure of attenuation to apply to labels as they are propagated through entity nodes to other entity nodes such that the labels are attenuated by each entity node that they pass through (e.g., the effective label weights of the labels are reduced by the third influence factor at each entity node through which the labels are propagated). High-valued third influence factors indicate that labels propagating through an entity node will experience a greater degree of attenuation than will be caused by low-valued third influence factors. Thus, for example, the third influence factor results in further damping of the effect of a label as it propagates further from the entity node from which it was injected by a label node.

By way of an example, a first entity node is directly connected to a second entity node through a first entity node/second entity node edge. The second entity node is directly connected to a third entity node through a second entity node/third entity node edge. The third entity node is not directly connected to the first entity node through an edge common to both the first and third entity nodes but is indirectly connected to the first entity node through the second entity node. When labels are propagated from the first entity node to the third entity node through the second entity node, the third influence factor operates through the second entity node to attenuate or dampen the weights or effects of the labels propagated from the first entity node to the third entity node. As such, the weights/effects of the labels propagated to the third entity node from the first entity node will be less than the weights/effects of the labels propagated from the first entity node to the second entity node. Likewise, the if the third entity node is directly connected to a fourth entity node (that is not directly connected to the first entity node) then the third influence factor would operate through the third entity node to further attenuate or dampen the weights/effects of the labels propagated from the first entity node to the fourth entity node. As such, the weights/effects of the labels propagated to the fourth entity node from the first entity node will be less than the weights/effects of the labels propagated from the first entity node to the third entity node.

Each of the influence factors for entity nodes in a graph can be determined, for example, based on the type of system represented by the graph (e.g., a social network or a web page co-visitation chart). In some implementations, a system administrator sets the influence factors. In a particular graph each entity node in the graph can have the same first, second and third influence factors as every other entity node in the graph or can have different influence factors than some or all of the other entity nodes. Further, some or all of the entity nodes in the graph may have only one or two of the influence factors.

In some implementations, for any given node, the first, second and third influence factors have positive values and can sum to one or can be normalized to sum to 1.0. For example, the first influence factor can be 1.0, the second influence factor can be 0.8 and the third influence factor can be 0.2. The influence factor values can be normalized to sum to 1 such that first influence factor can be normalized to 0.5, the second influence factor can be normalized to 0.4 and the third influence factor can be normalized to 0.1. Thus all of the influences on the entity node (whether the entity node has one, two or all three of the influence factors) are normalized such that the corresponding effects (e.g., label injections, label propagations and/or attenuations) from other elements in the graph on the entity node can also be normalized, as described in more detail below with reference to FIG. 4B. The processes 404 through 412 are repeated for other entity nodes in the graph (414). For example, the label generator 304 repeats processes 404 through 412 for all or a subset of entity nodes in the graph (e.g., a subset of interest such as a subset of entity nodes representing social network members in a member group).

The pre-normalized from-label weights, the pre-normalized between-entity edge weights and the influence values for the first, second and third influence factors are used as a set of linear constraints to determine final label weightings for the entity nodes (416). In some implementations, the label generator 304 uses the pre-normalized from-label edge weights, the pre-normalized between-entity edge weights and the influence values for the first, second and third influence factors as a “pre-normalized” set of linear constraints (e.g., matrices describing the graph) to determine final label weightings for the entity nodes. In some implementations, the label generator 304 uses, for example, a power law approach or a bi-conjugate gradient descent approach to determine final label weightings for the entity nodes based in part on the pre-normalized from-label and between-entity edge weights and influence factors, as described with reference to FIG. 4B.

As described above, once a system has been represented as a graph and the “pre-normalized” set of linear constraints determined, certain mathematical tools such as sparse-matrix solutions can be applied to determine how information propagates through the graph. For example, a power law approach can be applied to the set of linear constraints representing a graph (which represents a social network) and processed to determine how various interests propagate to and through entity nodes representing social network members. Without such pre-normalization reflected in the set of linear constraints, for example, the sparse-matrix solutions cannot be effectively applied and the efficiency benefits afforded by such solutions cannot be realized.

FIG. 4B is a flow diagram of an example process 450 for determining label weight values. The process 450 is based on a power law approach by which the “pre-normalized” set of linear constraints can be determined.

Labels from a previous iteration from each entity node are propagated to the other entity nodes to which the entity node is directly connected using a first propagation weighting (452). The first propagation weighting is a multiplicative combination (e.g., product) of the pre-normalized between-entity edge weight and the second influence factor for receiving entity node. In some implementations in which there have been no previous iterations, the previous iteration is the initial state of the graph (e.g., prior to any information being propagated).

In some implementations, the label generator 304 determines the first propagation weighting by multiplying the second influence factor for the entity node to which the label is being propagated (“the receiving entity node”) and the pre-normalized between-entity edge weight of the receiving entity node and the entity node from which the label is being propagating. Thus, with respect to entity node 114 and entity node 110, if the second influence factor for the entity node 114 is 0.4 then the first propagation weighting associated with entity node 114 and edge 116 is 0.32, which is the product of 0.4 (the second influence factor for entity node 114) and 0.8 (the between-entity edge weight for entity nodes 114 and 110 from Table 2). In a similar manner, assuming the second influence factor for the other entity nodes is also 0.4, the label generator 304 can determine the first propagation weighting for the other entity nodes in graph 100, as shown in Table 5:

TABLE 5

| | First Propagation Weighting (for |
|---|---|
| | labels from entity nodes) |
| Entity Node 114: Edge to 110 | 0.32 |
| Entity Node 114: Edge to 112 | 0.08 |
| Entity Node 110: Edge to 114 | 0.4 |
| Entity Node 112: Edge to 114 | 0.4 |

The first propagation weighting can be used to apportion the effects from labels propagated from other entity nodes to a receiving entity node to normalize such effects to the determined second influence factor value. Thus, in this example, the effects from labels propagated from other entity nodes (i.e., entity node 114) to the receiving entity node 110 will account for only 40% (e.g., the value of the second influence factor) of the change to the receiving entity node's labels for the current propagation iteration. The remainder of the change to the receiving entity node's labels is based on and attributed to the first and third influence factors, as described below.

The process 450 propagates labels from each label node to the entity nodes which the label node is directly connected using a second propagation weighting given by a multiplicative combination of the pre-normalized from-label weights and the first influence factor for the receiving entity node (454).

In some implementations the label generator 304 propagates labels from each label node to the entity nodes which the label node is directly connected. For example, the label generator 304 determines the second propagation weighting by a multiplicative combination of the pre-normalized from-label weights and the first influence factor for the receiving entity node. Thus, with respect to entity node 114 and label node 122, if the first influence factor for entity node 114 is 0.5 then the second propagation weighting for the label node 122 and the entity node 114 is 0.25, which is the product of 0.5 (the first influence factor for entity node 114) and 0.5 (the from-label weight for entity node 114 and label node 122 from Table 4). In a similar manner, assuming the second influence factor for the other entity nodes is also 0.5, the label generator 304 can determine the second propagation weighting for the other entity nodes in graph 100, as shown in Table 6:

TABLE 6

| | Second Propagation Weighting (for |
|---|---|
| | labels from label nodes) |
| Entity Node 114: Label Node 122 | 0.25 |
| Entity Node 114: Label Node 124 | 0.25 |
| Entity Node 110: Label Node 118 | 0.5 |
| Entity Node 112: Label Node 120 | 0.15 |
| Entity Node 112: Label Node 121 | 0.35 |

The second propagation weighting can be used to apportion the effects from labels injected into a receiving entity node to normalize such effects to the determined first influence factor value. Thus, in this example, the effects from labels injected by label nodes (i.e., label node 122 and 124) into the receiving entity node 114 will account for only 50% (e.g., the value of the first influence factor) of the change to the receiving entity node's labels for the current propagation iteration. Thus, for example, for a graph with first, second and third influence factor values of 0.5, 0.4 and 0.1, respectively, 50% of the change is from labels injected into the entity node 114 by label nodes (i.e., a linear constraint on the effect from injected labels) and 40% of the change to the labels of entity node 114 is from labels propagated to the entity node 114 by other entity nodes (i.e., a linear constraint on the effect from propagated labels). As such, 90% of the change to the labels of the entity node 114 for this iteration has been accounted for. The remaining 10% is based on and attributed to attenuation effects from the third influence factor (i.e., a linear constraint on the effect from attenuation).

Thus the first, second and third influence factor values, and the first and second propagation weightings define a “pre-normalized” set of linear constraints for determining how information propagates through the graph. In other words, by using the set of linear constraints, solutions that determine how information propagates through a graph result in label weights that are inherently normalized after propagation such that renormalization after propagation is not required. By using these linear constraints, as the effects from labels propagated from other entity nodes, the effects from injected labels and the attenuation effects are normalized, respectively, to the second, first and third influence factor values, and the influence factor values sum (e.g. to 1 or equivalently 100%), the cumulative effect from all changes to the labels of a receiving entity node during a propagation iteration will also be normalized. The label weights are pre-normalized upon receipt by the receiving entity node. There is no need to renormalize the labels before the next propagation iteration or other future iterations occur, which permits sparse-matrix solutions to be applied to the graph and the accompanying efficiency benefits to be realized.

The propagated labels are summed on a per-label basis to provide a current iteration's label weight for each entity node (456). In some implementations the label generator 304 sums the propagated labels on a per-label basis to provide a current iteration's label weight for each entity node. For example, if a Sports label with a first label weight was propagated to a receiving entity node by another entity node and a Sports label with a second label weight was injected into the receiving entity node by a label node, then the label generator 304 sums the first and second label weights to determine a final label weight for Sports for the receiving entity node for the iteration (assuming there are no additional Sports labels propagated to or injected into the receiving entity node). Thus for each receiving entity node and each label received, the label generator 304 sums the label weights on a per-label basis for all or a subset of the entity nodes in the graph.

In some implementations, the process 450 iterates until a specified number of iterations have occurred. The specified number of iterations can be set by an administrator as a static value or can be a dynamic value. For example, the process 450 can iterate until the label weights for some or all of the entity nodes reach a convergence threshold such that the iteration-over-iteration change of one or more label weights from the set of entity nodes is less than the convergence threshold.

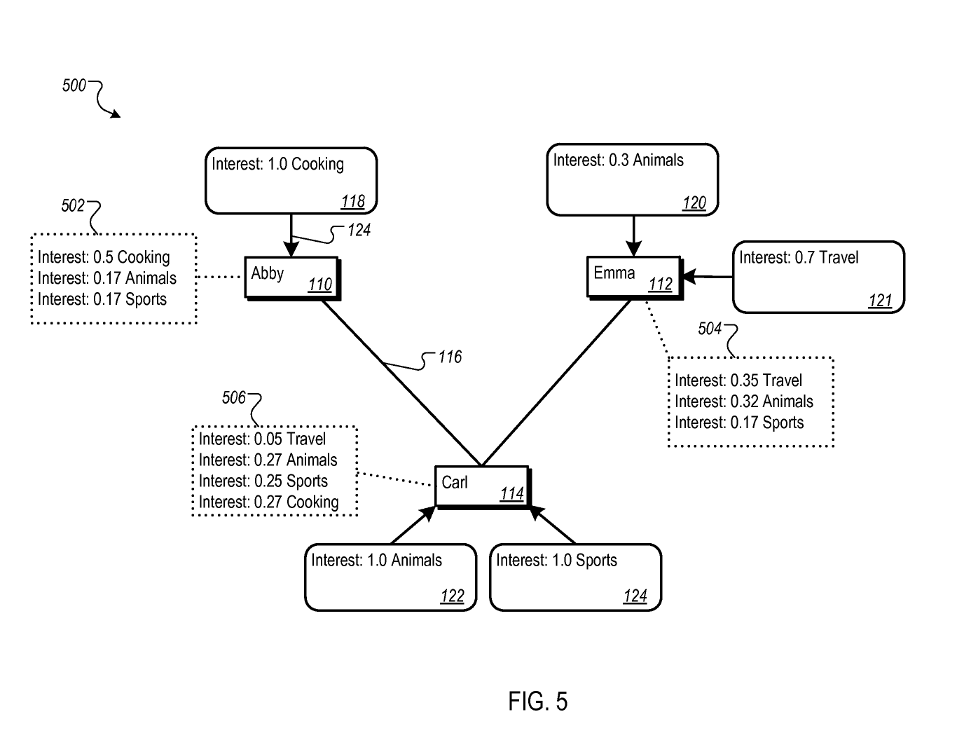

FIG. 5 is example graph 500 of a social network where a pre-normalized set of linear constraints are used during label propagations. More particularly, FIG. 5 shows a new state of the graph 100 of FIG. 1 after an initial round of propagation, e.g., after a first iteration of the process 400. In this example, the entity nodes have labels (and label weights) that are determined based on labels propagated by neighboring entity nodes and labels injected by connected label nodes. For example, the label generator 304 can determine the labels for entity node 110 to be Animals with a label weight of 0.17, propagated from entity node 114, Sports with a label weight of 0.17, propagated from entity node 114, and Cooking with a label weight of 0.5 injected by label node 118. The labels associated with Abby (represented by entity node 110) after the first iteration are shown in block 502. Similarly, the labels associated with Emma (represented by entity node 112) and Carl (represented by entity node 114) after the first iteration are shown in blocks 504 and 506, respectively.

As the set of linear constraints for the graph 100 were “pre-normalized” prior to the iteration, there is no need to normalize the label weights after the iteration. Thus the labels in blocks 502, 504 and 506 are already normalized. As such, the process 450 can iterate again without any further renormalization of the current labels (i.e., the labels in blocks 502, 504 and 506), which allows propagation solutions based on the power law or bi-conjugate gradient descent to be applied to the graph to determine how labels (or information more generally) flow through the graph. More particularly, graphs (e.g., graph 100 and 500) can be represented by one or more matrices and the various methods for sparse-matrix solutions can be applied to the matrices to determine how information propagates through the graph.

In some implementations, the label generator 304 can identify entity nodes in the graph that have no (incoming) positively-weighted from-label edges as without-direct-label nodes and can identify entity nodes that have no positively-weighted incoming between-entity edges as disconnected nodes. For example, if an entity does not have any connections to a label node or to another entity node, the label generator 304 can identify the entity node as both a without-direct-label node and a disconnected node.

If an entity node is identified as both a disconnected entity node and a without-direct-label node, the label generator 304 can remove the entity node from the graph (or matrix representing the graph) and remove any edges that originate from the entity node. In this way the label generator 304 can simplify the graph and reduce the need to track and account for such entity nodes. In some implementations, the label generator 304 uses a Gaussian elimination process to remove the entity nodes.

In some implementations, the values for the first influence factor for entity nodes identified as without-direct-label nodes are set to zero, as there are no labels injected into the without-direct-label nodes. Likewise, in some implementations, the values for the second influence factor for entity nodes identified as disconnected entity nodes are set to zero, as such disconnected entity nodes do not propagate labels to other entity nodes.

In some implementations, to reduce the complexity of the graph (e.g., in addition or alternatively to removing entity nodes) the label generator 304 can eliminate label nodes if the label itself is not of interest and/or does not substantially affect (e.g., the effect is below some threshold label weight change) a solution to the set of linear constraints (“uninteresting label”). For example, a network administrator may identify uninteresting labels. Such elimination can be performed, with little or no change to the final label distribution/weighting, as long as the edges from the full set of label nodes to the entity nodes are considered in the pre-normalized process before these uninteresting labels are removed or eliminated. Such removal or elimination reduces the number of computations (e.g., matrix-vector multiplies) which must be performed for any given propagation iteration. Furthermore, the number of iterations that are used to reach the final solution (e.g., a solution that meets a convergence criterion) for any one label can be different from the number of iterations used for any other label, without effecting the accuracy of the other label distributions/weightings. This effect is based on the independence resulting from the “pre-normalization process.” In other words, the pre-normalization permits each label to be handled independently from all other labels.

The label generator 304 can eliminate entity nodes from the graph whose label weights do not substantially affect label weights of entity nodes in the graph after a predetermined number of iterations (e.g., does not substantially affect a solution based on the above-mentioned set of linear constraints). An entity node does not substantially affect label weights of other entity nodes in the graph if the effect the entity node has on other entity nodes is below some threshold label weight change measure. For example, the threshold label weight change measure can be based on a relative change in a particular label weight caused by propagations of labels from the entity node (e.g., a 5% change in an entity node's label weight). In turn, the label generator 304 can bypass computations of the eliminated entity nodes'effects in the graph to reduce the computational burden on the label generator 304.

In some implementations, the label generator 304 uses a Gaussian elimination process to eliminate the entity nodes while maintaining the eliminated entity nodes' effects on the label weights of other entity nodes in the graph. This can be performed after several iterations, as described above, or it can be performed before the propagation process, as long as Gaussian elimination is used. The immediate elimination is performed when the to-be-eliminated node is not, in and of itself, of interest. For example, when a user drops out of a social network, but we want to maintain the second order connections amongst his former friends. The Gaussian elimination must be performed after the weight normalization has been completed on the between entity connections/edges. At that point, the normalization that has been imposed, along with the mechanics of Gaussian elimination, result in the removal of the entity node not having an effect on the final label distribution/weighting of any other entity nodes. Furthermore, as the connection structure from each node is sparse, Gaussian elimination of such a node is much less computationally burdensome than would otherwise be suggested by the full size of the graph.

Although process 450 is based on a power law solution approach, as described above, other approaches such a bi-conjugate gradient descent approach can be used. Bi-conjugate gradient descent is performed by separately solving for each label, each solution giving that label's distribution across the full network/graph. This has the advantage that the graph networks that are used for each label can be modified, using the previously described processes and techniques, in different ways for each label, according to the distribution and propagation characteristics of that single label. For example, in some implementations, the label generator 304 can determine the selected-label weightings for entity nodes in a graph after an iteration by solving a “pre-normalized” set of linear constraints (e.g., constraints based on the pre-normalized from-label weights, the pre-normalized between-entity edge weights and the influence values for the first, second and third influence factors) using a bi-conjugate gradient descent approach. Further in some implementations this is accomplished by separately computing the bi-conjugate gradient descent to solve for each label independently (e.g., a per-label basis). For example, with respect to graph 100, the label generator 304 can use a bi-conjugate gradient descent approach to solve for each of the four labels: Travel, Animal, Sports and Cooking.

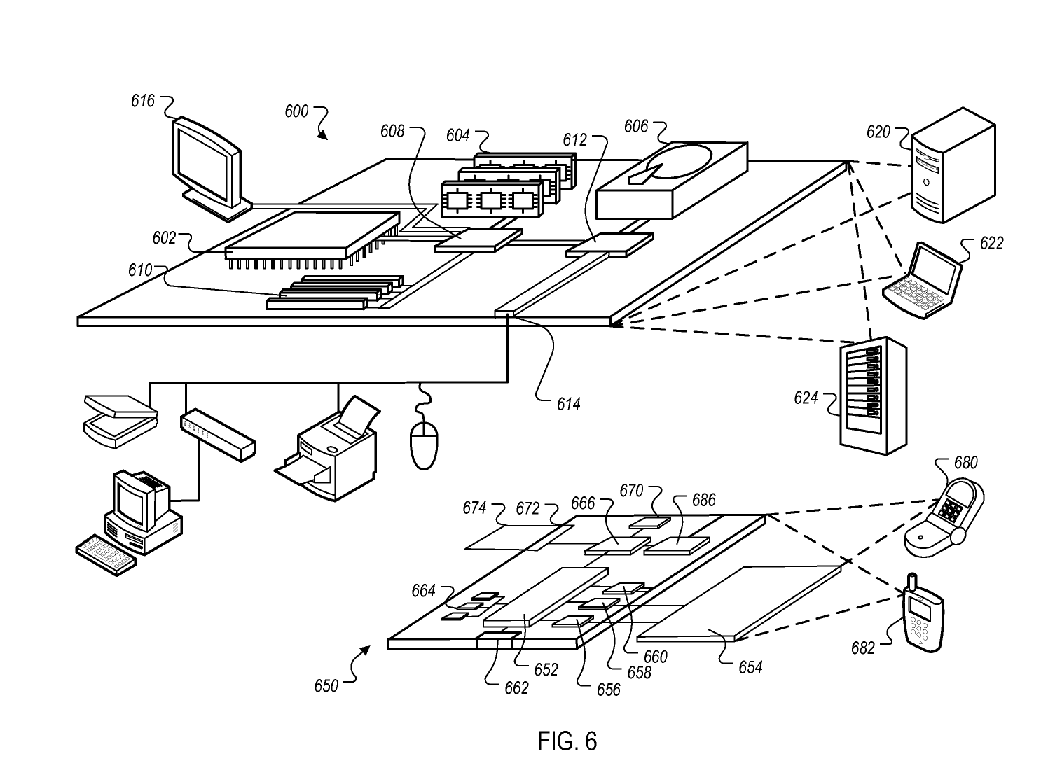

FIG. 6 is a block diagram of computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In some implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In some implementations, the memory 604 is a computer-readable medium. In some implementations, the memory 604 is a volatile memory unit or units. In other implementations, the memory 604 is a non-volatile memory unit or units.

The storage device 606 is capable of providing mass storage for the computing device 600. In some implementations, the storage device 606 is a computer-readable medium. In various different implementations, the storage device 606 may be a floppy disk device, a hard disk device, an optical disk device, or a tape device, a flash memory or other similar solid state memory device, or an array of devices, including devices in a storage area network or other configurations. In some implementations, a computer program product is tangibly embodied in an information carrier. The computer program product contains instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of duties is exemplary only. In some implementations, the high-speed controller 808 is coupled to memory 604, display 616 (e.g., through a graphics processor or accelerator), and to high-speed expansion ports 610, which may accept various expansion cards (not shown). In some implementations, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, and an input/output device such as a display 654, a communication interface 666, and a transceiver 668, among other components. The device 650 may also be provided with a storage device, such as a Microdrive or other device, to provide additional storage. Each of the components 650, 652, 664, 654, 666, and 668, are interconnected using various buses, and several of the components may be mounted on a common motherboard or in other manners as appropriate.

The processor 652 can process instructions for execution within the computing device 650, including instructions stored in the memory 664. The processor may also include separate analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD display or an OLED display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication (e.g., via a docking procedure) or for wireless communication (e.g., via Bluetooth or other such technologies).

The memory 664 stores information within the computing device 650. In some implementations, the memory 664 is a computer-readable medium. In some implementations, the memory 664 is a volatile memory unit or units. In some implementations, the memory 664 is a non-volatile memory unit or units. Expansion memory 674 may also be provided and connected to device 650 through expansion interface 672, which may include, for example, a SIMM card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hack able manner.

The memory may include for example, flash memory and/or MRAM memory, as discussed below. In some implementations, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 may communicate wirelessly through communication interface 866, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, Wi-Fi, or other such transceiver (not shown). In addition, GPS receiver module 670 may provide additional wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. In certain implementations, the label nodes do not have to be high-level semantic nodes. Instead, they may be individual keywords. For example, they may be the union of the set of keywords that occur on every user's page/description of themselves and every group's description, etc.

In some implementations, there may be keywords that are uncommon. For example, the common word “the” may not provide much information, but the relatively uncommon keyword “basketball” may. These types of words can be used by classifying module 324 when implementing, for example, the common TF-IDF (term frequency-inverse document frequency) measure. Additionally, the keywords can be selected from terms that advertisers often use to target online ads, or keywords including hand-selected terms that are of interest.

The term “member” or “user” can be substituted for other entities such as keywords, advertisers, ad groups, etc.

In certain implementations, the set of labels used can include advertisements. For example, the labels propagated through the graph can include advertisements on which one or more members have clicked. In this implementation, after advertisement labels are inferred throughout a graph, for each member, the label generator 304 can output a set of advertisements on which each member may be likely to click.

In another implementation, the label generator 304 can select labels for members to target ads, etc., where the labels are derived based on an initial machine-learning classification, or the label generator 304 can use the inferred labels generated by executing the above algorithms and methods on the graph to infer labels for each members. In addition, the logic flows depicted in the figures do not require the particular order shown, or sequential order, to achieve desirable results. In addition, other steps may be provided, or steps may be eliminated, from the described flows, and other components may be added to, or removed from, the described systems. For example, the first and second data stores 306, 308 can reside in a single storage device, such as a hard drive.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer implemented method comprising:
providing data representing a data structure that includes a plurality of nodes, a portion of the nodes being entity nodes and a portion of the nodes being label nodes, wherein at least some entity nodes are connected to other entity nodes by one or more incoming or outgoing weighted edges, and wherein at least some label nodes are connected to entity nodes by one or more outgoing weighted edges;
for each entity node:
computing an aggregated incoming between-entity edge weight for the entity node including adding the weights of the edges that are incoming to the entity node from other entity nodes;
when there are one or more positively-weighted incoming between-entity edges into the entity node, replacing each of the between-entity edge weights by a respective initial edge weight of the between-entity edge divided by the aggregated incoming between-entity edge weight to generate pre-normalized between-entity edge weights;
computing an aggregated from-label weight by adding the label weights from label nodes with edges that are incoming to the entity node;
when there are one or more positively-weighted from-label node edges into the entity node, replacing each of the corresponding label weights from the label nodes by a respective initial label weight from the label node divided by the aggregated from-label weight to generate pre-normalized from-label weights;
determining influence values for each of a plurality of influence factors, where each influence factor is associated with a degree of propagation through the data structure of label weights to the entity nodes, and where the influence values are all non-negative and sum to one; and
using the pre-normalized from-label weights, the pre-normalized between-entity edge weights and the influence values as a set of linear constraints to determine final label weightings for the entity nodes.

2. The method of claim 1, further comprising:
when there are no positively-weighted from-label edges into the entity node, identifying the entity node as a without-direct-label node; and
for each entity node that is both a disconnected entity node and a without-direct-label node, removing the entity node from the data structure and removing any edges that originate from the entity node.

3. The method of claim 1, further comprising:
determining the final label weighting for the entity nodes including, for one or more iterations:
propagating labels from a previous iteration from each entity node to the other entity nodes to which the entity node is directly connected using a first propagation weighting given by a multiplicative combination of the pre-normalized between-entity edge weights and a second influence factor from incoming-from-entity-node edges, from the plurality of influence factors, for an entity node receiving the propagated label weights;
propagating labels from each label node to the entity nodes which the label node is directly connected using a second propagation weighting given by a multiplicative combination of the pre-normalized from-label edge weights and a first influence factor from direct-from-label injections, from the plurality of influence factors, for the receiving entity node; and
summing the propagated labels on a per-label basis to provide a current iteration's label weight for each entity node.

4. The method of claim 1, further comprising:
determining the final label weightings for the entity nodes by solving a set of linear constraints using bi-conjugate gradient descent.

5. The method of claim 4, wherein:
determining the final label weightings comprises separating a computation of the bi-conjugate gradient descent to solve for each label independently.

6. The method of claim 5, wherein:
determining the final label weightings comprises eliminating label nodes and bypassing the computation of a label's distribution for all labels whose final distribution does not substantially affect a solution to the set of linear constraints.

7. The method of claim 5, wherein:
determining the final label weightings comprises eliminating entity nodes from the computation for all entity nodes whose final label weighting does not substantially affect a solution to the set of linear constraints.

8. The method of claim 7, wherein eliminating entity nodes from the computation comprises eliminating entity nodes by Gaussian elimination of the entity node while maintaining the entity node's influence on a final weighting distribution.

9. The method of claim 1, wherein the entity nodes represent social entities and the label nodes represent interest.

10. The method of claim 9, wherein the edge weights between entity nodes are determined by a number, length, or recentness of a message exchanged between the social entities.

11. The method of claim 1, wherein the entity nodes represent advertisement sites and the label nodes represent advertisement triggering keywords.

12. The method of claim 11, wherein the edge weights between entity nodes are determined by a number, consistency, or recentness of user visits to the advertisement sites within a single user session and within a pre-defined time period.

13. The method of claim 1, wherein the entity nodes represent content sites and the label nodes represent content topics.

14. The method of claim 13, wherein the edge weights between entity nodes are determined by a number, consistency, or recentness of user visits to the content sites within a single user session and within a pre-defined time period.

15. The method of claim 1, further comprising:
when there are no positively-weighted incoming between-entity edges into the entity node, identifying the entity node as a disconnected entity node.

16. The method of claim 1, wherein an influence value for a first influence factor from direct-from-label injections, from the plurality of influence factors, is set to zero for the entity nodes that are identified as a without-direct-label node and an influence value for a second influence factor from incoming-from-entity-node edges, from the plurality of influence factors, is set to zero for entity nodes that are identified as a disconnected entity node.

17. A method for propagating labels in a social graph comprising:
providing a social graph that includes a plurality of nodes and includes edges connecting the nodes, a portion of the nodes being user nodes, a portion of the nodes being injection nodes that inject a label into a respective user node and a portion of the nodes being uncertainty nodes that inject a measure of attenuation to be applied when propagating labels between user nodes;
determining for a given node an influence value for label weights for each of three factors: influence for injections, influence for neighbors and influence for uncertainty;
determining weights for labels at each node including normalizing at receipt weights for labels that are propagated or injected into a user node including:
normalizing the weights for labels injected into a node, and adjusting the normalized weights by the influence factor for injections to produce an injected label weight contribution for the label for the node;
adjusting the weights for labels received from a neighbor by the influence factor for neighbors to produce a neighbor label weight contribution for the label for the node; and
using the weights and influence values as a set of linear constraints to determine final label weightings for the nodes.

18. The method of claim 17, wherein a sum of the influences is equal to one.

19. The method of claim 17, wherein normalizing at receipt weights for labels includes determining for each neighbor a contribution for a label being propagated to a target user node from the neighbor.

20. The method of claim 19, wherein normalizing on receipt further includes determining an influence factor for each neighbor that is contributing labels to a target user node, adjusting a label weight for a label propagated from the neighbor in accordance with the neighbors influence to produce a first adjusted label weight, and adjusting the first adjusted label weight by the influence factor for neighbors to produce the neighbor label weight contribution for the node.

21. The method of claim 20, wherein the influence factors for each neighbor sums to one.

22. The method of claim 20, wherein the influence factors for each neighbor are the same.

23. A method for propagating labels in a social graph comprising:
identifying a first user node in a social graph;
identifying one or more labels that are injected into the first user node, thereby associating respective labels with the first user node;
normalizing weights of the labels that are injected into the first user node to be equal to one;
determining an influence factor for injected labels for the first user node;
adjusting the normalized weights for the labels using the influence factor for injected labels to produce a injected label weight contribution for each label associated with the first user node;
determining if there are other neighbor nodes that contribute labels to the first user node;
determining an influence factor for the neighbor nodes;
when there are neighbor nodes, determining a neighbor node contribution for each label propagated from a respective neighbor node including identifying a label weight for a label from the neighbor node, adjusting the label weight based on an effective influence of the neighbor node on the first user node, and further adjusting the adjusted label weight based on the determined influence factor for the neighbor node; and
summing the neighbor node contribution with the injected weight contribution for each label for the first user node;
storing the sum for each label, producing a label weight for label for the first user node; and
propagating the label weight for each label to one or more neighbor nodes to the first user node.

24. The method of claim 23, further comprising attenuating a contribution of one or both of the neighbor nodes and injected labels to the label weights using an uncertainty factor.

25. The method of claim 24, wherein the values of influence factors for injected labels, the influence factor for neighbors and the uncertainty factor sum to equal 1.0.

26. The method of claim 25, wherein the attenuation is equal for both the influence factor for labels and the influence factor for neighbors.

27. A method for propagating labels in a social graph comprising:
identifying one or more labels associated with a user in a social graph, where the user is connected to one or more other users in the social graph;
identifying an influence value for label weights for each of at least two factors for the user: influence for injections and influence for neighbors;
determining weights for labels for the user including normalizing at receipt weights for labels that are propagated or associated with a user including:
normalizing the weights for labels associated with the user and adjusting the normalized weights by the influence value for injections to produce an injected label weight contribution for the user;
adjusting the weights for labels received from a neighbor by the influence value for neighbors to produce a neighbor label weight contribution for the user; and
using the weights and influence values as a set of linear constraints to determine final label weightings for the user.

28. The method of claim 27, wherein identifying an influence value for label weights for each of at least two factors for the user further includes identifying an influence for uncertainty, wherein the influence for uncertainty is an attenuation factor for use in propagating the labels for a user to other neighbors.

29. The method of claim 28 wherein the sum of the influence factors is equal to one.

30. The method of claim 29, wherein the influence for uncertainty, when a positive non-zero value, effects to attenuate the influence of injected or neighbor weights on the weights of labels to be associated with a user.

31. A method implemented by a computer system, the method comprising:
identifying, by the computer system, a set of labels to be associated with users of a social network, the labels including one or more designators for specifying areas of interest for a respective user;
labeling, using the identified labels, nodes in a graph that represents the social network, wherein the users are represented by user nodes in the graph;
assigning, by the computer system and for each respective node, weights for the labels, each weight reflecting a magnitude of a contribution of an associated label to a characterization of the respective node, wherein assigning weights includes:
determining initial weights for each label that is either injected into a node or propagated from a neighbor node;
determining an influence factor for labels that are injected to a node and labels that are propagated from other neighbor nodes;
adjusting the initial weights based on the influence factors; and
using the adjusted weights and influence factors as a set of linear constraints to determine final label weightings for the nodes.

32. The method of claim 31, wherein identifying the set of labels further comprises retrieving the labels from a profile associated with a user associated with a respective node.

33. The method of claim 31, further comprising implicitly assigning labels to users based on historical activities of the user.

34. The method of claim 31, wherein labeling includes assigning labels based on an evaluation of content associated with a user.

35. The method of claim 31, wherein labeling includes assigning labels based on a combination of explicit designations and implicit determinations.

36. The method of claim 35, wherein implicit determinations are made based on user interaction with content.

37. The method of claim 36, wherein the user interactions are click-throughs.

38. The method of claim 31, further comprising determining a relative level of interest that is associated with each label for a given user.

39. The method of claim 38, wherein the relative level of interest is expressed in terms of a percentage.

40. The method of claim 38, wherein the relative level of interest is normalized.

41. The method of claim 31, wherein propagating the labels includes propagating the labels to a neighbor node based at least in part on the assigned weights and types of connections between respective nodes.

42. The method of claim 41, wherein propagating the labels includes determining a label weight to propagate for each label to an adjoining node based at least in part on an assigned weight of a respective label and a weight associated with a connection to the adjoining node.

43. The method of claim 31, wherein identifying a set of labels includes identifying one or more groups that a user is included in and includes identifying one or more labels associated with a respective group and assigning the one or more labels to each member of the respective group.

44. The method of claim 31, further comprising targeting content to respective users based at least in part on the labels and the label weights.

45. The method of claim 31, wherein the labels are keywords.

46. The method of claim 31, wherein the labels are uncommon keywords associated with a user.

47. The method of claim 31, wherein each node is connected to less than all of the other user nodes with which a user has a relationship.

48. The method of claim 31, wherein edges connect the user nodes and are weighted based on one or more of: a user's explicit designation of a relative weighting between relationships, two users' mutual explicit designation of affirmation of a relationship, or a measure of degree of relatedness of a node to other nodes in the graph.

49. The method of claim 31, wherein the user represents a group of users.

50. The method of claim 31, wherein the labels are advertisements.

51. The method of claim 31, wherein the graph includes one or more uncharacterized label nodes that are used to reduce the effect of far away nodes on a respective node.

52. The method of claim 31, wherein a connection between nodes represents a relationship.

53. The method of claim 52, wherein the relationship is a social relationship.

54. The method of claim 52, wherein the relationship is a friendship specified by a user represented by a respective node.

55. The method of claim 52, wherein the relationship is selected from a group consisting of a relationship based on group membership specified by a user represented by a respective node, a relationship based on similarity between content generated by the users represented by the respective node and the neighboring nodes, and a relationship based on similarity of a web-site visiting pattern.

56. The method of claim 31, wherein the user nodes representing the users of the social network comprise group nodes representing groups of users and individual user nodes representing individual users.

57. The method of claim 31, further comprising generating the graph that includes the nodes and reflects relationships between the nodes as edges connecting the nodes.

58. The method of claim 57, wherein the edges are weighted based on factors selected from a group consisting of whether the relationships are bi-directional, a number of links between the nodes, a frequency that a user visits another user's profile, and payment terms specified by advertisers.

59. The method of claim 31, further comprising outputting, for each respective node, weights for the labels based on weights of labels associated with neighboring nodes, which are related to the respective node by a relationship.

60. A computer implemented method comprising:
identifying one or more labels of interest to be associated with users of a user group;
classifying each user including determining an association between the one or more labels and each respective user where the labels include areas of interest as either explicitly or implicitly determined for a given user;
providing a first graph of the user group that includes a plurality of nodes, one node for each user and one or more label nodes that inject weights for the labels into each respective user node, including providing edges between user nodes that represent relationships between the users and assigning labels to each user based on the classifying;
determining weights for each label for each user node in the first graph including:
normalizing the weights for labels injected into a node, and adjusting the normalized weights by an influence factor for injections to produce an injected label weight contribution for the label for the node;
adjusting the weights for labels received from a neighboring node by an influence factor for neighbor nodes to produce a neighbor label weight contribution for the label for the node; and
using the weights and influence factors as a set of linear constraints to determine final label weightings for the user nodes.
